(19) United States
(12) Patent Application Publication
(10) Pub. No.: US 2023/0117417 A1
(43) Pub. Date: Apr. 20, 2023

(54) Magnesium phosphate-alkali activated composite cementitious material with rapid hardening, early strength, and high water resistance

(71) Applicant: FUZHOU UNIVERSITY, Fuzhou City (CN)

(72) Inventors: Xujian LIN, Fuzhou City (CN); Tao JI, Fuzhou City (CN); Yongning LIANG, Fuzhou City (CN); Hwaichung WU, Fuzhou City (CN); Hongru ZHANG, Fuzhou City (CN); Xinyuan LIN, Fuzhou City (CN); Chenfeng LIN, Fuzhou City (CN)

(21) Appl. No.: 18/047,407

(22) Filed: Oct. 18, 2022

(30) Foreign Application Priority Data
Oct. 18, 2021 (CN) 202111211517.1

(51) Int. Cl. C04B 9/04; C04B 9/20; C04B 18/14

(52) U.S. Cl. CPC C04B 9/04; C04B 9/20; C04B 18/146

(57) ABSTRACT

The present disclosure discloses a novel magnesium phosphate-alkali activated composite cementitious material with rapid hardening, early strength, and high water resistance and a preparation method thereof. The composite cementitious material is a mixture system of a magnesium phosphate cementitious material interweaving and coexisting with an alkali-activated cementitious material, where the alkali-activated cementitious material is prepared by alkali activation of an activatable mineral using a hydration product of a high-alkalinity magnesium phosphate cementitious material prepared from an alkaline hydrophosphate. The composite cementitious material obtained ensures excellent mechanical properties while actively converting part of or all of air-hardening material components into a hydraulic material, so that the problem of poor water resistance of the magnesium phosphate cementitious material can be effectively solved.

### CROSS REFERENCE TO RELATED APPLICATION

This patent application claims the benefit and priority of Chinese Patent Application No. 202111211517.1, filed with the China National Intellectual Property Administration on Oct. 18, 2021, the disclosure of which is incorporated by reference herein in its entirety as part of the present application.

### TECHNICAL FIELD

The present disclosure belongs to the technical field of materials, and particularly relates to a novel magnesium phosphate-alkali activated composite cementitious material with rapid hardening, early strength, and high water resistance and a preparation method thereof.

### BACKGROUND

Magnesium phosphate cement (MPC) was first used as a material for structural repair and waste curing due to its excellent properties. Since the MPC is a non-hydraulic cement, the main product, MgNH₄PO₄.6H₂O (MAP) or MgKPO₄.6H₂O (MKP), has poor water resistance, which largely limits application fields thereof. In view of the problem of poor water resistance of the MPC, the present disclosure proposes to prepare high-alkalinity magnesium phosphate cement by using alkaline hydrophosphate. The alkaline solution after hydration can further activate mineral materials, and convert part of magnesia cementitious materials into alkali-activated cementitious materials to form a mixture system of a magnesium phosphate cementitious material interweaving and coexisting with a hydraulic alkali-activated material, thereby effectively improving the overall water resistance of the system.

### SUMMARY

An objective of the present disclosure is to provide a novel magnesium phosphate-alkali activated composite cementitious material with rapid hardening, early strength, and high water resistance and a preparation method thereof. According to the preparation method, with dead-burned magnesia (DBM), alkaline hydrophosphate, silica fume, and an activatable mineral as solid raw materials, water is supplied and replenished internally to enable the raw materials to spontaneously form a rapid-hardening, early-strength, and high-water-resistance cementitious material that is interwoven with a magnesium phosphate cementitious material and a hydraulic alkali-activated product. This material can effectively solve the problems of poor water resistance of the magnesium phosphate cementitious material and weakened structural strength thereof in humid environments.

To achieve the above objective, the present disclosure adopts the following technical solutions:

A novel magnesium phosphate-alkali activated composite cementitious material with rapid hardening, early strength, and high water resistance is provided. The composite cementitious material is a mixture system of a magnesium phosphate cementitious material interweaving and coexisting with an alkali-activated cementitious material, where the alkali-activated cementitious material is prepared by alkali activation of an activatable mineral using a hydration product of a high-alkalinity magnesium phosphate cementitious material prepared from an alkaline hydrophosphate.

A preparation method of the composite cementitious material includes the steps of: using DBM, an alkaline hydrophosphate, silica fume, water, an activatable mineral, and a water storage material as raw materials, mixing the raw materials in a mixer into a mold, hardening for 3-24 h, demolding, and air-curing a hardenite (soaking curing is not suitable) to prepare the composite cementitious material.

Herein, the following raw materials are used: 38-52 parts by weight of the DBM, 8-20 parts by weight of the alkaline hydrophosphate, 6-20 parts by weight of the silica fume, 8-20 parts by weight of the water (0-12 parts by weight of which is used to pre-wet the water storage material), 6-28 parts by weight of the activatable mineral, and 0.2-9 parts by weight of the water storage material.

The alkaline hydrophosphate is monohydrogen phosphate.

The activatable mineral includes any one or more of mineral slag, pozzolan, and fly ash.

The water storage material is at least one of a water-absorbent resin or a porous water-absorbent material (for example, ceramsite).

The magnesium phosphate cementitious material is sensitive to the quantity of mixing water in the early stage of formation, and is characterized by rapid reaction (represented as early strength and rapid hardening), so most of the mixing water added is quickly and substantially consumed in the early stage of the reaction, and substantial crystals of highly alkaline substances are accumulated in the system (the reaction is shown in formula 1). By adding only a small quantity of water and using internal water replenishment (adding a water storage material) in the early stage, the present disclosure not only avoids the negative impact of using too much initial mixing water on a magnesium phosphate cementitious material system to retain the advantages of early strength and rapid hardening, but also regulates the gradual release of the water to promote the activation effect of the resulting highly alkaline substances on the activatable mineral, so that hydraulic products are produced by secondary hydration in the system, thereby improving the water resistance of the composite cementitious material.

MgO+K₂HPO₄.3H₂O+3H₂O MgKPO₄.6H₂O+KOH (1).

The present disclosure has the following prominent advantages:

The present disclosure uses the DBM, the alkaline hydrophosphate, the silica fume, and the activatable mineral as main raw materials, and provides necessary water that can promote primary and secondary hydration through internal water supply (combined with the water storage material), thereby preparing a composite cementitious material with rapid hardening, early strength, and high water resistance. The material not only retains the advantages of the magnesium phosphate cementitious material, but also activates the activatable mineral to produce hydraulic products by using a unique highly alkaline substance produced by a reaction of magnesia with monohydrogen phosphate under the condition of internal water replenishment (namely without adding an additional activator), effectively improving the water resistance of the material. In addition, the incorporation of activatable mineral components can further reduce the quantity of magnesia and hydrogen phosphate to reduce costs, and has excellent technical, economic and environmental benefits.

### BRIEF DESCRIPTION OF THE DRAWINGS

FIG. 1 is a scanning electron microscopy (SEM) image of a magnesium phosphate cementitious material and an energy dispersive spectrum (EDS) of the corresponding marked sites.

FIG. 2 is an SEM image of a magnesium phosphate-alkali activated composite cementitious material and an EDS spectrum of the corresponding marked sites.

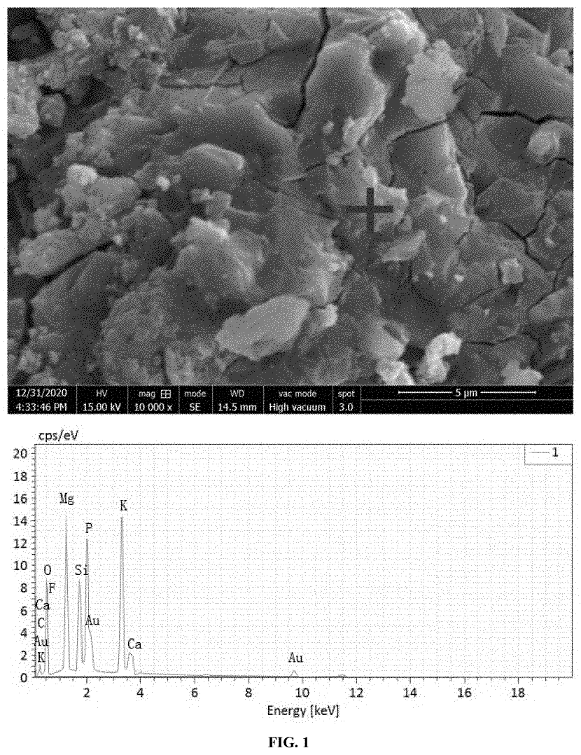

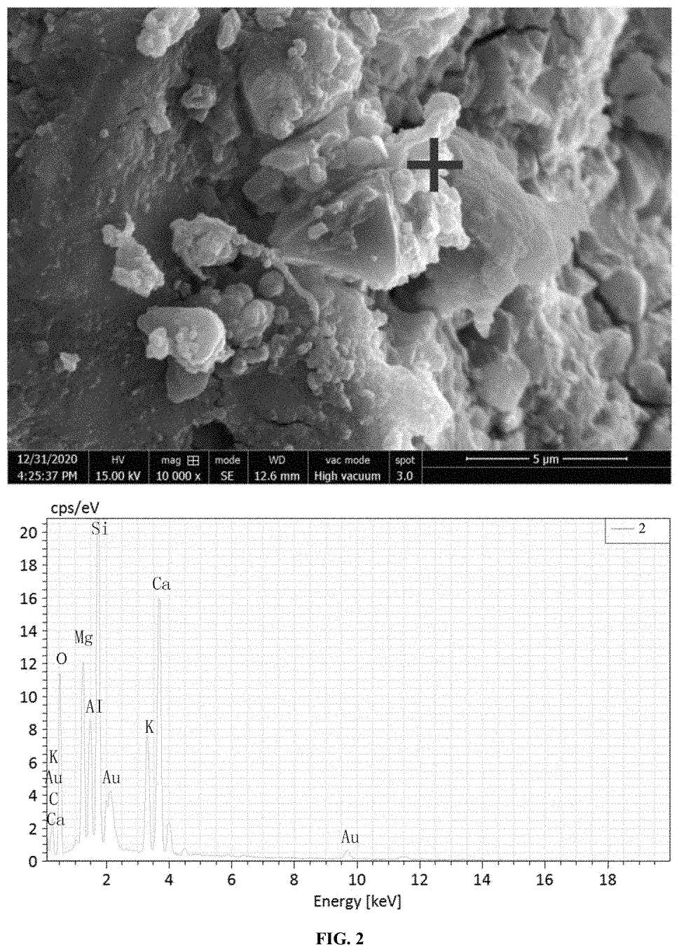

From the figures, the marked site in FIG. 1 is MKP, the main hydration product of the magnesium phosphate system; in FIG. 2, there is a white gelatinous substance attached to the surface of the marked site MKP, and the energy spectrum thereof shows peak values of the elements, Si, Ca, and O, are more prominent, and it can be confirmed that the substance is C-(A)-SH, indicating that the mineral slag can be activated in the system, and together with MKP, constitute a magnesium phosphate-alkali activated composite system.

### DETAILED DESCRIPTION OF THE EMBODIMENTS

In order to make the objective, design scheme and superiority of the present disclosure more intuitive, the present disclosure will be further described below in conjunction with specific examples. Obviously, the described examples are only a part of, not all of, the examples. Based on the examples of the present disclosure, all other examples obtained by those of ordinary skill in the art without creative efforts fall within the protection scope of the present disclosure, but the protection scope of the present disclosure is not limited thereto.

### Example 1

Separately, 40 parts by weight of DBM, 13 parts by weight of dipotassium hydrogen phosphate, 8 parts by weight of silica fume, 25 parts by weight of mineral slag, 0.3 parts by weight of super absorbent polymer (SAP), and 9 parts by weight of water (2.5 parts by weight of which was used to pre-wet the SAP) were weighed. First, the SAP was fully mixed with 2.5 parts by weight of water for pre-wetting, and the pre-wet SAP and the remaining raw materials were poured into a mortar mill for full mixing, poured for molding, and air-cured for at least 3 h to obtain a novel magnesium phosphate-alkali activated composite cementitious material.

The compressive strength of the magnesium phosphate-alkali activated composite cementitious material obtained after air-curing for 59 days was 68 MPa; the compressive strength of one after air-curing for 3 days and immersion in water for 56 days increased from 35.3 MPa to 66.7 MPa, its compressive strength after immersion increased by 89%, and its strength retention rate after immersion was 98%.

### Example 2

Separately, 40 parts by weight of DBM, 13 parts by weight of dipotassium hydrogen phosphate, 8 parts by weight of silica fume, 25 parts by weight of mineral slag, 0.3 parts by weight of SAP, and 9 parts by weight of water were weighed. All raw materials were poured into a mortar mill for full mixing (so that the SAP absorbed part of the water in the early stage of stirring and released it in the later stage), poured for molding, and air-cured for at least 3 h to obtain a novel magnesium phosphate-alkali activated composite cementitious material.

The compressive strength of the magnesium phosphate-alkali activated composite cementitious material obtained after air-curing for 59 days was 75 MPa; the compressive strength of one after air-curing for 3 days and immersion in water for 56 days increased from 50 MPa to 71.2 MPa, its compressive strength after immersion increased by 42.4%, and its strength retention rate after immersion was 94.9%.

### Example 3

Separately, 49 parts by weight of DBM, 20 parts by weight of dipotassium hydrogen phosphate, 10 parts by weight of silica fume, 7.5 parts by weight of mineral slag, 2.5 parts by weight of pottery sand, and 9 parts by weight of water (0.2 parts by weight of which was used to pre-wet the pottery sand) were weighed. First, the pottery sand was fully mixed with 0.2 parts by weight of the water for pre-wetting, and the pre-wet pottery sand and the remaining raw materials were poured into a mortar mill for full mixing, poured for molding, and air-cured for at least 3 h to obtain a novel magnesium phosphate-alkali activated composite cementitious material.

The compressive strength of the magnesium phosphate-alkali activated composite cementitious material obtained after air-curing for 59 days was 81.5 MPa; the compressive strength of one after air-curing for 3 days and immersion in water for 56 days increased from 49.5 MPa to 77.2 MPa, its compressive strength after immersion increased by 56%, and its strength retention rate after immersion was 94.7%.

### Comparative Example 1

Separately, 40 parts by weight of DBM, 13 parts by weight of dipotassium hydrogen phosphate, 8 parts by weight of silica fume, 25 parts by weight of mineral slag, and 9 parts by weight of water were weighed. All raw materials were poured into a mortar mill for full mixing, poured for molding, and air-cured for at least 3 h to obtain a magnesium phosphate cementitious material (because no water storage material was contained, the mixing water was quickly consumed, so that the magnesium phosphate-alkali activated composite cementitious material could not be formed in the subsequent reaction after the magnesium phosphate cementitious material was generated).

The compressive strength of the magnesium phosphate cementitious material obtained after air-curing for 59 days was 81.6 MPa; the compressive strength of one after air-curing for 3 days and immersion in water for 56 days increased from 51.6 MPa to 73.8 MPa, its compressive strength after immersion increased by 43%, and its strength retention rate after immersion was 90.4%.

### Comparative Example 2

Separately, 40 parts by weight of DBM, 13 parts by weight of dipotassium hydrogen phosphate, 8 parts by weight of silica fume, and 9 parts by weight of water were weighed. All raw materials were poured into a mortar mill for full mixing, poured for molding, and air-cured for at least 3 h to obtain a magnesium phosphate cementitious material.

The compressive strength of the magnesium phosphate cementitious material obtained after air-curing for 59 days was 90.6 MPa; the measured compressive strength of one after air-curing for 3 days and immersion in water for 56 days increased from 60.3 MPa to 74.5 MPa, its compressive strength after immersion increased by 23.5%, and its strength retention rate after immersion was 82.2%.

### Comparative Example 3

Separately, 49 parts by weight of DBM, 20 parts by weight of dipotassium hydrogen phosphate, 1.5 parts by weight of borax, 2.5 parts by weight of pottery sand, and 9 parts by weight of water (0.2 parts by weight of which was used to pre-wet the pottery sand) were weighed. First, the pottery sand was fully mixed with 0.2 parts by weight of the water for pre-wetting, and the pre-wet pottery sand and the remaining raw materials were poured into a mortar mill for full mixing, poured for molding, and air-cured for at least 3 h to obtain a conventional magnesium phosphate cementitious material (the system pH was too low to reach activation conditions).

The compressive strength of the magnesium phosphate cementitious material obtained after air-curing for 59 days was 59 MPa; the compressive strength of one after air-curing for 3 days and immersion in water for 56 days decreased from 54 MPa to 42.1 MPa, its strength decreased, and its strength retention rate after immersion was 71.3%.

Compared with the conventional magnesium phosphate cementitious material, the long-term retention rate of compressive strength after immersion of the magnesium phosphate-alkali activated composite cementitious material provided by the present disclosure is significantly improved; compared with the common silicate cementitious material, the early strength of the magnesium phosphate-alkali activated composite cementitious material provided by the present disclosure is still high, no retarder is required, and the advantages of early strength and rapid hardening of magnesium-based cementitious materials are retained. The innovation of the present disclosure lies in the combination of preparation technologies of the magnesium phosphate and the alkali-activated cementitious materials. Under the condition of internal water supply and water replenishment, mineral materials in the alkali activation system of the specific magnesium-based cementitious material are used to produce hydraulic alkali-activated products, thereby improving the overall water resistance of the material, which not only retains the respective advantages of the two cementitious material systems, but also contributes to environmental protection, waste recycling, and cost reduction, and has significant social, economic and technical benefits.

The above descriptions are only preferred examples of the present disclosure, and all equivalent variations and modifications made in accordance with the scope of the patent application of the present disclosure shall fall within the scope of the present disclosure.

What is claimed is:

1. A magnesium phosphate-alkali activated composite cementitious material with rapid hardening, early strength, and high water resistance, wherein the composite cementitious material is a mixture system of a magnesium phosphate cementitious material interweaving and coexisting with an alkali-activated cementitious material, wherein the alkali-activated cementitious material is prepared by alkali activation of an activatable mineral using a hydration product of a high-alkalinity magnesium phosphate cementitious material prepared from an alkaline hydrophosphate.

2. A preparation method of the magnesium phosphate-alkali activated composite cementitious material according to claim 1, comprising the steps of: using dead-burned magnesia (DBM), the alkaline hydrophosphate, silica fume, water, the activatable mineral, and a water storage material as raw materials, mixing the raw materials into a mold, hardening, demolding, and air-curing a hardenite to prepare the composite cementitious material.

3. The preparation method of the magnesium phosphate-alkali activated composite cementitious material according to claim 2, wherein the following raw materials are used: 38-52 parts by weight of the DBM, 8-20 parts by weight of the alkaline hydrophosphate, 6-20 parts by weight of the silica fume, 8-20 parts by weight of the water, 6-28 parts by weight of the activatable mineral, and 0.2-9 parts by weight of the water storage material.

4. The preparation method of the magnesium phosphate-alkali activated composite cementitious material according to claim 2, wherein the alkaline hydrophosphate is monohydrogen phosphate.

5. The preparation method of the magnesium phosphate-alkali activated composite cementitious material according to claim 3, wherein the alkaline hydrophosphate is monohydrogen phosphate.

6. The preparation method of the magnesium phosphate-alkali activated composite cementitious material according to claim 2, wherein the activatable mineral comprises any one or more of mineral slag, pozzolan, and fly ash.

7. The preparation method of the magnesium phosphate-alkali activated composite cementitious material according to claim 3, wherein the activatable mineral comprises any one or more of mineral slag, pozzolan, and fly ash.

8. The preparation method of the magnesium phosphate-alkali activated composite cementitious material according to claim 2, wherein the water storage material is at least one of a water-absorbent resin or a porous water-absorbent material.

9. The preparation method of the magnesium phosphate-alkali activated composite cementitious material according to claim 3, wherein the water storage material is at least one of a water-absorbent resin or a porous water-absorbent material.
